(19) United States
(12) Patent Application Publication
(10) Pub. No.: US 2011/0271297 A1
(43) Pub. Date: Nov. 3, 2011

(54) SYSTEM AND METHOD FOR MANAGING MEDIA CONTENT AND PROVIDING SUGGESTED ALTERNATIVES

(75) Inventor: Mark Gilmore Mears, Zionsville, IN (US)

(73) Assignee: SHENZHEN TCL NEW TECHNOLOGY LTD., Shekou, Shenzhen, Guangdong (CN)

(21) Appl. No.: 12/680,708

(22) PCT Filed: Oct. 31, 2007
(86) PCT No.: PCT/US07/83230

§ 371 Date: Mar. 29, 2010

(30) Foreign Application Priority Data
Oct. 18, 2007 (CN) 200710124027.1

(51) Int. Cl. H04N 7/16

(52) U.S. Cl. 725/28

(57) ABSTRACT

There is provided a system and method for managing media content and providing suggested alternatives. More specifically, in one embodiment, there is provided a method comprising identifying at least one characteristic of a program that relates to content of the program, comparing the at least one characteristic to a control setting, and adding the program to a safe list for display on a menu screen if the at least one characteristic is deemed acceptable based on the comparison with the control setting.

### FIELD OF THE INVENTION

The present invention relates generally to managing the content of programming provided through an electronic media device, and more particularly to directing a user to unblocked programming.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A media management device may be utilized to block certain programs from being provided through a particular media device. For example, a V-Chip may be considered as a type of a media management device. Specifically, the V-Chip may be defined as hardware, software, or combination thereof that cooperates with an electronic media device (e.g., a television, a VCR, a television set top box or the like) to block certain types of programming that are designated as undesirable by a user. For example, the V-Chip may allow parents to block television programming that they do not want their children to watch due to violent or sexual content.

Many television programs have been assigned a rating indicator based on content in accordance with broadcasting industry standards. For example, in the United States, the Federal Communications Commission (FCC) has adopted a rating system with the following labels and content indicators where labels (“ratings”) and content indicators (sometimes collectively referred to generically as “ratings”, as well) for a given rating can be set independently from each other:

### Labels (“Ratings”):

TV-Y—All Children

TV-Y7—Directed to Older Children

TV-G—General Audience

TV-PG—Parental Guidance Suggested

TV-14—Parents Strongly Cautioned

TV-MA—Mature Audience Only

### Content Indicators:

Fantasy violence (FV)

Violence (V)

Sexual (S)

Language (L)

Suggestive dialogue (D).

See http://www.fcc.gov/vchip/

A user may utilize a V-Chip or another media control feature to block programming of a certain type by configuring blocking criteria of the V-Chip or media control feature. For example, the FCC ratings set forth above may be utilized as criteria for blocking a particular program. When a user attempts to tune to a program that is blocked on an electronic media device employing a media control feature, the device may merely display a blocking message or statement indicating that the content is blocked. Accordingly, the users are essentially required to scan through various channels to find something that is unblocked and accessible. For example, children attempting to watch television with parental controls in place may be required to tune to numerous channels before they find a channel that is unblocked and available to view.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a process flow diagram showing a process in accordance with an exemplary embodiment of the present invention;

FIG. 3 is a diagram of a menu screen in accordance with an exemplary embodiment of the present invention; and

FIG. 4 is a process flow diagram showing a process in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary Embodiment of the present invention provides an automated search for media content that is not blocked by a media control feature of a media device (e.g., a television or the like). The results of the search may be displayed or implemented in a list of available content for selection by a user. It is believed that such an automated search feature will cooperate with media control features to facilitate a user's efficient enjoyment of inoffensive and available media. For example, when a media control feature blocks programming because a rating or some other characteristic (e.g., a title) associated with the programming is outside of the limits allowed for display by the media control feature, embodiments of the present invention will not require the user to keep turning channels in search of programming that is unblocked. This will save the user time and frustration when trying to find media suitable for viewing.

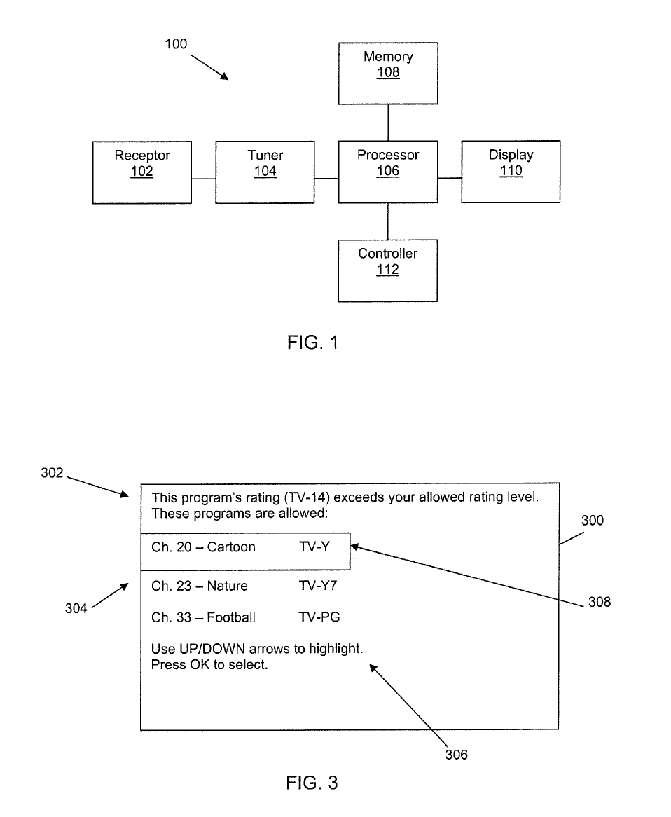

FIG. 1 is a block diagram of an electronic device in accordance with an exemplary embodiment of the present invention. The electronic device (e.g., a television or the like) is generally indicated by reference numeral 100. Those of ordinary skill in the art will appreciate that the various functional blocks shown in FIG. 1 may comprise hardware elements (including circuitry), software elements (including computer code stored on a machine-readable medium) or a combination of both hardware and software elements. The electronic device 100 comprises a receptor 102 (e.g., a cable inlet or an antenna), a receiver or tuner 104, a processor 106, a memory 108, a display 110, and a controller 112.

The memory 108 may include one or more memory devices. For example, the memory 108 may include volatile memory components, non-volatile memory components, or a combination thereof. The memory 108 may be adapted to hold machine-readable computer code that causes the processor 106 to perform an exemplary method in accordance with the present techniques. In one embodiment, the memory 108 may store computer code that blocks undesirable channels based on user established criteria (e.g., content ratings). Further, the memory 108 may store computer code that causes the processor to provide suggestions regarding alternative programming that is available (i.e., unblocked). For example, upon turning to a program that is blocked, the device 100 may display a screen indicating what channels are providing content that is unblocked during a certain time period. In another example, upon activation of the device (e.g., when a television is turned on), the device 100 may display a screen indicating what programming is available and unblocked.

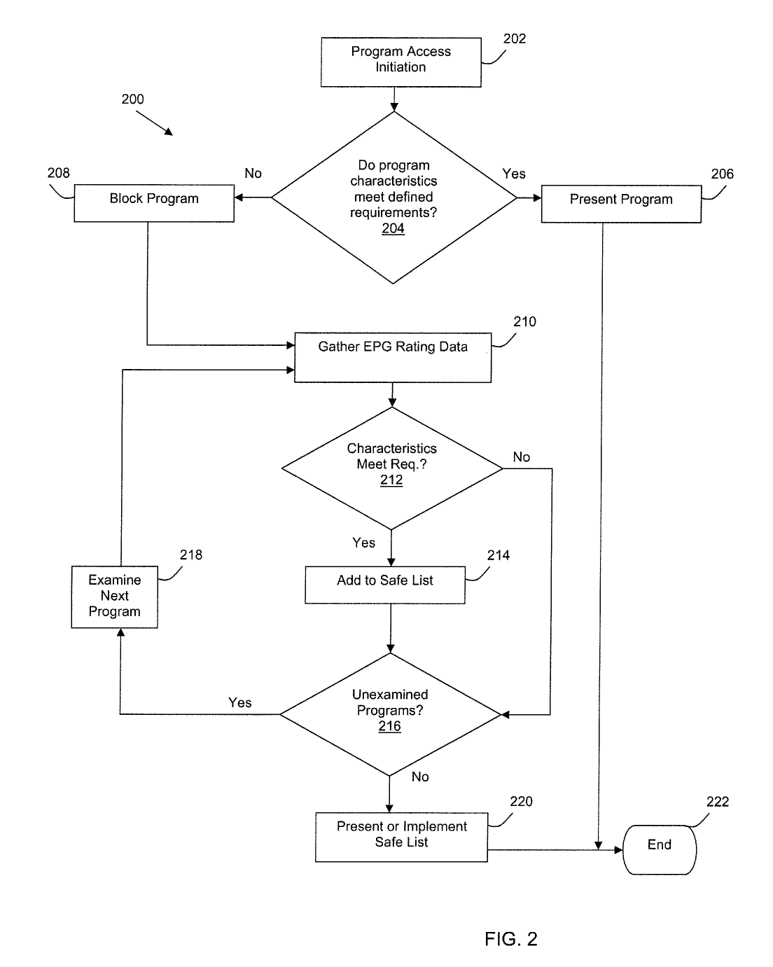

FIG. 2 is a process flow diagram showing a process in accordance with an exemplary embodiment of the present invention. The process is generally indicated by reference numeral 200 and begins with block 202. Specifically, block 202 represents attempting to access programming on a media device (e.g., a television). For example, block 202 may represent changing the channel on a television or turning on a television. Once the channel is selected, a determination is made regarding whether the programming on the channel is appropriate for presentation, as represented by block 204. For example, a rating value assigned to the programming may be compared to a user-set allowable rating value to determine if the programming exceeds what is allowed to be displayed by a media control feature. If the programming is acceptable (i.e., meets the prescribed criteria), the process 200 displays the program, as represented by block 206. If the programming fails to meet the prescribed criteria, the process continues to block 208, which represents blocking the programming from presentation on the media device. For example, block 208 may represent blocking audio, video, and/or captions from being presented via the media device.

When content is blocked, as represented by block 208, the process 200 examines program data (e.g., electronic programming guide (EPG) data or the like) and determines whether the ratings of the programs corresponding to the program data meet the prescribed criteria of the media control feature. This is represented by blocks 210 and 212 in FIG. 2. Specifically, for example, the ratings data for each program available on the EPG is gathered, as represented by block 210. Next, a determination is made regarding whether each of the programs from the EPG meets the standards of the media control feature, as represented by block 212. Each program may be considered individually. If the characteristics (e.g., ratings) of a particular program fail to meet the user-defined standards, that particular program is skipped over and the process continues to block 216. However, if the characteristics of the program meet the user-defined standards, as determined in block 212, the program is added to a list of available and unblocked programming, which may be referred to as a “safe list.” This addition of the approved or acceptable programming to the safe list is represented by block 214.

Each time a program is added to the safe list, a determination is made as to whether any programs from the EPG remain unexamined. In other words, the process 200 determines whether all of the programs from the EPG have been examined to establish whether or not they comply with the defined preferences. This determination is represented by block 216. If a determination is made that additional programs have not yet been examined, the process continues to block 218, which represents initiating examination of a next program. In contrast, if a determination is made that there are no more programs from the EPG that have not been examined, the process proceeds to block 220. Block 220 represents presenting the display list. For example, block 220 may represent displaying the safe list on the screen or implementing the display list as a scan list. A scan list may include a list of channels that are cycled through when the up and down arrows are toggled on a controller for the media device. The process ends at block 222.

FIG. 3 is a diagram of a menu screen in accordance with an exemplary embodiment of the present invention. The menu screen is generally indicated by reference numeral 300. In the illustrated embodiment, the menu screen 300 includes text 302 that provides notice regarding the blocked status of a particular program and the reason it was blocked. Further, the menu screen includes a navigable list 304 of available programming. Instructional text 306 is also included in the menu screen 300, which explains that a user may cycle through the navigable list 304 and select a particular program for presentation. Indeed, a user may highlight a particular member of the navigable list 304 with a cursor 308 and select that program for viewing on a television. This will facilitate efficient access to subject matter deemed suitable by a content control feature. It should be noted that the menu screen 300 is an example of a screen including a safe list that may be produced in accordance with present techniques, as represented by block 220 in FIG. 2. It should also be noted that a safe list may be produced in accordance with present techniques without first attempting to access a blocked program.

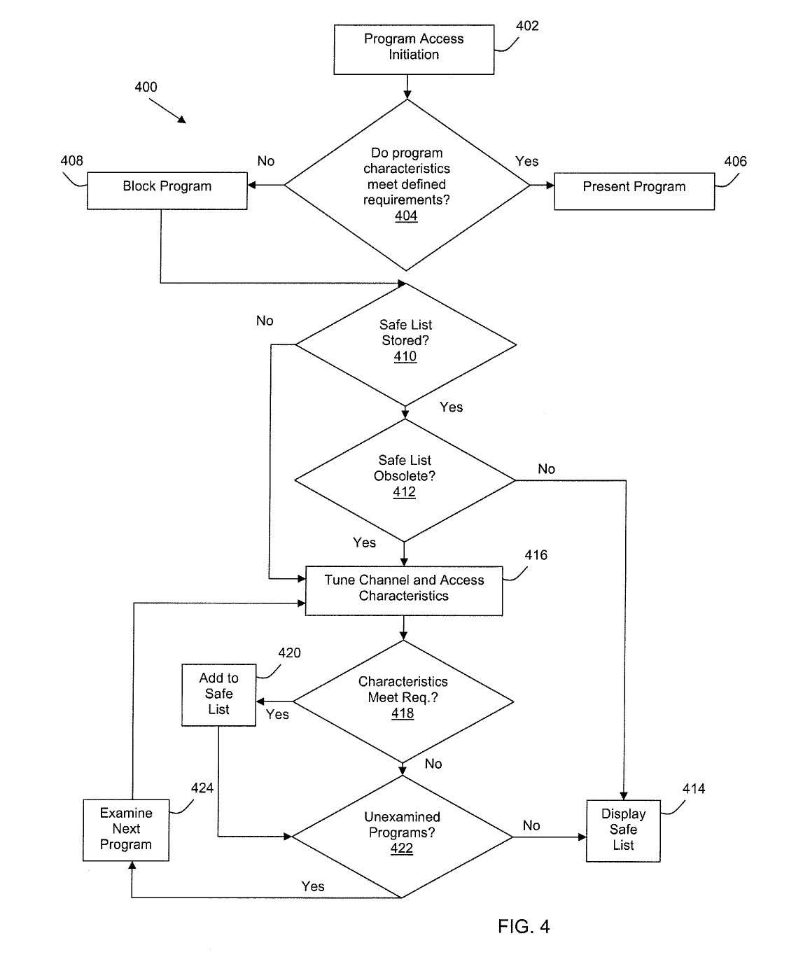

FIG. 4 is a process flow diagram showing a process in accordance with an exemplary embodiment of the present invention. The process is generally indicated by reference numeral 400 and begins with block 402. Specifically, block 402 represents attempting to access programming on a media device. For example, block 402 may represent changing the channel on a television or turning on a television. Once the channel is selected, a determination is made regarding whether the programming on the channel is appropriate for presentation, as represented by block 404. For example, a rating value assigned to the programming may be compared to a user-set allowable rating value to determine if the programming exceeds what is allowed to be displayed by a media control feature. If the programming is acceptable, the process 400 displays the program, as represented by block 406. If the programming is unacceptable, the process continues to block 408, which represents blocking the programming from presentation on the media device. Block 408 may also represent presentation of a screen similar to that of FIG. 3 indicating that a safe list is being constructed or acquired.

When content is blocked, as represented by block 408, a determination is next made regarding whether a safe list has already been put in place, as represented by block 410. For example, a previous safe list may already be in place that can be utilized immediately instead of constructing a new safe list. However, the programming associated with the stored safe list may have expired. In other words, the safe list may be obsolete. For example, a typical television program may last approximately thirty minutes and the stored safe list may have been created over thirty minutes prior to accessing it. Accordingly, a determination is made in block 412 regarding whether the safe list is obsolete (e.g., over thirty minutes old). In other embodiments, the age of the safe list may be compared to a standard programming schedule to determine whether the safe list is obsolete. If the safe list is not obsolete, the process 400 continues to block 414, which represents presentation of the safe list. However, if the safe list is obsolete, a new safe list is constructed, as discussed below. In some embodiments, a new safe list may be automatically generated based on a timer or based on some other indication. In other embodiments, a new safe list may be generated each time the user changes channels. In yet other embodiments, only the channels of those programs that have ended are re-examined.

If a new safe list is to be constructed, each available channel or each channel is a defined list is analyzed to determine whether it meets the requirements of the content management feature. Specifically, a tuner, such as tuner 104, may be utilized to access each available channel and its characteristics, as represented by block 416. Indeed, block 416 represents examining the extended data service (XDS) or program and system information protocol (PSIP) data for a particular channel. For example, if an analog channel is accessed, this may include examining line 21 of the program's XDS data, which carries content advisory (V-Chip) information. In another example, if a digital channel is accessed, this may include examining a content advisory descriptor in an event information table (EIT) or in the PSIP. Other media formats may have their own unique ratings data protocol. Once a certain characteristic or characteristics of the tuned program are obtained, the characteristics (e.g., rating, title, metadata tag, or keyword) are compared with the settings of the content control feature to determine whether the program should be blocked or unblocked. In other words, a determination is made as to whether the program is accessible, as represented by block 418. If the program is accessible, it is added to the safe list, as represented by block 420. Otherwise, the process proceeds to block 422 to determine whether additional programs should be considered.

Each time a program is added to the safe list or is deemed unavailable, a determination is made as to whether any available programs remain unexamined. In other words, the process 400 determines whether all of the programs have been examined to establish whether or not they comply with the defined preferences. This determination is represented by block 422. If a determination is made that additional programs have not yet been examined, the process continues to block 424, which represents initiating examination of a next program. In contrast, if a determination is made that there are no more programs that have not been examined, the process proceeds to block 414. As set forth above, block 414 represents presenting the display list. For example, block 414 may represent displaying the safe list on the screen or implementing the display list as a scan list. A scan list may include a list of channels that are cycled through when the up and down arrows are toggled on a controller for the media device. It should be noted that, in accordance with present embodiments, multiple tuners or a single tuner with dual functionality may be utilized to enable viewing of a program while building a safe list.

While the present techniques may be susceptible to various modifications and alternative forms, specific embodiments have been shown by way of example in the drawings and are described in detail herein. However, it should be understood that the techniques are not intended to be limited to the particular forms disclosed. Further, certain aspects of the disclosed processes may be performed in an order different than that illustrated. It should be noted that the disclosed techniques are to cover all modifications, equivalents and alternatives falling within the spirit and scope of the techniques as defined by the following appended claims.

What is claimed is:

1. A method of preparing a safe list for presentation on a media device, comprising:
identifying at least one characteristic of a program that relates to content of the program;
comparing the at least one characteristic to a control setting; and
adding the program to the safe list for display on a menu screen if the at least one characteristic is deemed acceptable based on the comparison with the control setting.

2. The method of claim 1, wherein determining the at least one characteristic of the content comprises determining a rating.

3. The method of claim 1, wherein determining the at least one characteristic of the content comprises determining a title, a metadata tag or keyword associated with the content.

4. The method of claim 1, comprising gathering electronic programming guide data to facilitate identifying the at least one characteristic.

5. The method of claim 1, comprising tuning a particular channel to facilitate identifying the at least one characteristic.

6. The method of claim 1, comprising determining whether all potentially available programming has been analyzed and continuing to a different program if all potentially available programming has not been analyzed.

7. The method of claim 1, comprising presenting the safe list as a navigable list on the menu screen.

8. The method of claim 1, comprising blocking the program from presentation if the at least one characteristic is deemed unacceptable based on the comparison with the control setting.

9. The method of claim 1, wherein identifying the at least one characteristic comprises analyzing extended data service data or program and system information protocol data.

10. The method of claim 1, comprising initiating preparation of the safe list only after attempting to tune a blocked channel.

11. The method of claim 1, comprising initiating preparation of the safe list when a user command to prepare the safe list is received.

12. The method of claim 1, comprising initiating preparation of the safe list when the media device is turned on.

13. A method, comprising:
attempting to access a program;
determining that the program is blocked by a content management feature;
gathering data regarding programs that are not blocked by the content management feature; and
presenting a list of the programs that are not blocked by the content management feature.

14. The method of claim 13, comprising gathering electronic programming guide data to determine content of the other programs.

15. The method of claim 13, wherein the list of the programs that are not blocked by the content management feature comprises a selectable list of program titles.

16. The method of claim 13, comprising determining whether a previous list of unblocked programs has already been constructed.

17. The method of claim 16, wherein gathering data comprises accessing the previous list.

18. The method of claim 13, comprising displaying an available program while gathering the data.

19. The method of claim 13, comprising displaying text indicating that the list is being processed when it is determined that the program is blocked.

20. A system, comprising:
means for processing data;
means for storing data;
means for tuning a signal for a program;
means for identifying at least one characteristic of the program that relates to content of the program;
means for comparing the at least one characteristic to a control setting; and
means for adding the program to a safe list for display on a menu screen if the at least one characteristic is deemed acceptable based on comparing the at least one characteristic to the control setting.
